(19) United States
(12) Patent Application Publication
(10) Pub. No.: US 2008/0318609 A1
(43) Pub. Date: Dec. 25, 2008

(54) Portable Terminal and Method for Determining a Frequency Assignment

(75) Inventor: Ki Young Sung, Seoul (KR)

Correspondence Address: BLANK ROME LLP, 600 NEW HAMPSHIRE AVENUE, N.W., WASHINGTON, DC, 20037, US

(73) Assignee: Posdata Co., Ltd.

(21) Appl. No.: 12/159,473

(22) PCT Filed: Dec. 27, 2006
(86) PCT No.: PCT/KR06/05772

§ 371 Date: Jun. 27, 2008

(30) Foreign Application Priority Data
Dec. 29, 2005 (KR) 10-2005-0133258

(51) Int. Cl. H04Q 7/00; H04B 7/26

(52) U.S. Cl. 455/509

(57) ABSTRACT

Provided is a broadband wireless access communication system, and in particular, a portable terminal and method for determining a FA in a portable Internet system. A method for determining a FA to be used for wireless communication in a portable terminal includes the steps of: (a) checking whether a signal for each FA is detected and obtaining the number of available FAs of a target base station; (b) obtaining a media access control (MAC) address of the portable terminal; (c) determining a FA based on the MAC address and the number of available FAs; and (d) performing connection initialization through the determined FA.

### TECHNICAL FIELD

The present invention relates to a broadband wireless communication system, and more particularly, to a portable terminal and method for determining a frequency assignment (FA) in a portable Internet system.

### BACKGROUND ART

Portable Internet is a next generation communication mechanism capable of supporting mobility, as well as local area data communication using a fixed access point such as a conventional wireless local area network (LAN).

FIG. 1 schematically illustrates a portable Internet system. The portable Internet system includes a subscriber station (SS) 200, a Radio Access Station (RAS) 300 for performing wireless communication with the subscriber station, an Access Control Router (ACR) 400 connected to the RAS 300 through a gateway, and an Internet network.

A wireless LAN method, which is specified on IEEE (Institute of Electrical and Electronics Engineers) 802.11, provides a data communication method capable of performing wireless communication using a fixed access point within a local area. However, this method only supports wireless local area data communication for the subscriber station (SS), and does not support the mobility of the SS.

Meanwhile, in the portable Internet system on which the IEEE 802.16 group, etc. are working, even when the SS 200 illustrated in FIG. 1 moves from a cell under the control of the RAS 300 to another cell under the control of another RAS, data communications service is provided without interruption to thus ensure mobility.

Also, various standards for the portable Internet have been proposed. At present, international standards for portable Internet have been developed based on IEEE 802.16d and 802.16e. The IEEE 802.16d and 802.16e communications systems, which are Broadband Wireless Access (BWA) communication systems, include a Base Station (BS) that controls the number of FAs. The SS communicates with the BS through one of FAs. When a terminal initially establishes a communication channel with the base station, the terminal performs communication for initialization through a primary FA, and then performs communication by selecting one of the FAs available on the base station.

As the number of the FAs each base station can use is increased, the capacity can be increased. If terminals are distributed for each FA, Quality of Service (QoS) can be improved and excellent communication quality can be guaranteed. However, the cost of installing and maintaining base station devices increases in proportion to the number of FAs. Therefore, wireless communication businesses providing mobile communication or portable Internet service generally allows a base station to use a single primary FA in the early stage of establishing a service system network. Thereafter, devices can be further installed as necessary in response to increasing communication traffic loads within an area where the primary base station has been installed to upgrade the network system to use multiple frequency assignment (“multi-FA”).

In the case of a base station that operates according to multi-FA, terminals located within the base station's domain should be equally distributed for each FA, so that traffic loads are distributed to obtain excellent communication quality. However, in the conventional art, each portable terminal that is initially connected to a base station performs initialization using only a primary FA, and then changes a FA according to traffic load environment information of the base station, so that the traffic loads are distributed.

In the above method of distributing the FAs according to the conventional art, when a portable terminal first connects to the base station, it is connected only to the primary frequency regardless of traffic load status. Therefore, when a new terminal tries to connect while the primary frequency is saturated, connection is impossible or the quality of the primary frequency may deteriorate.

In other words, when a specific FA is heavily loaded by terminals, traffic throughput deteriorates. Also, multimedia services that require the QoS (e.g., motion picture service, video call service, etc.) may not be provided to some terminals. In a case of the primary FA, even if additional FAs are added, these problems cannot be overcome.

Further, the portable terminal is initialized using the primary FA and then switched to another FA by using a protocol standard including a process in which the portable terminal transmits a signal several times. Consequently, the portable terminal consumes a considerable amount of power.

### DISCLOSURE OF INVENTION

### Technical Problem

The present invention is directed to a portable terminal and method of performing a frequency assignment (FA) capable of preventing a traffic load on a primary frequency.

The present invention is also directed to a portable terminal and method of performing communication through a FA for distributing traffic loads from an initialization stage.

The present invention is also directed to a portable terminal and method of performing a FA capable of efficiently distributing traffic loads to a plurality of FAs without terminal power consumption.

The present invention is also directed to a portable terminal and method of assigning a FA capable of efficiently distributing traffic loads to a plurality of FAs using a media access control (MAC) address for Internet communication.

### Technical Solution

One aspect of the present invention provides a method of determining a FA to be used for wireless communication. The method is performed in a portable terminal and includes the steps of: (a) checking whether a signal for each FA is detected and obtaining the number of available FAs of a target base station; (b) obtaining a media access control (MAC) address of the portable terminal; (c) determining a FA based on the MAC address and the number of available FAs; and (d) performing connection initialization through the determined FA.

Another aspect of the present invention provides a portable terminal including: a wireless core module for transmitting and receiving a wireless signal to/from a portable Internet base station; a MAC address obtainer for obtaining a MAC address from the wireless core module; a FA scanner for checking whether a wireless signal for each FA is detected and obtaining the number of available FAs of a target base station; and a FA determination module for determining a FA to be used according to the MAC address and the number of available FAs of the base station.

### ADVANTAGEOUS EFFECTS

According to a method of determining a FA of the present invention, traffic loads can be efficiently distributed to a plurality of FAs without terminal power consumption.

Also, since a MAC address, which is an identifier granted for Internet communication, is used in the present invention, a terminal does not need a separate identifier for distributing traffic loads to a plurality of FAs.

### BRIEF DESCRIPTION OF THE DRAWINGS

The above and other objects, features and advantages of the present invention will become more apparent to those of ordinary skill in the art by describing in detail preferred embodiments thereof with reference to the attached drawings in which:

FIG. 1 illustrates a configuration of a general portable Internet system;

FIG. 2 is a block diagram illustrating a portable terminal for wireless Internet according to an exemplary embodiment of the present invention; and

FIG. 3 is a flowchart illustrating a method of determining a FA according to an exemplary embodiment of the present invention.

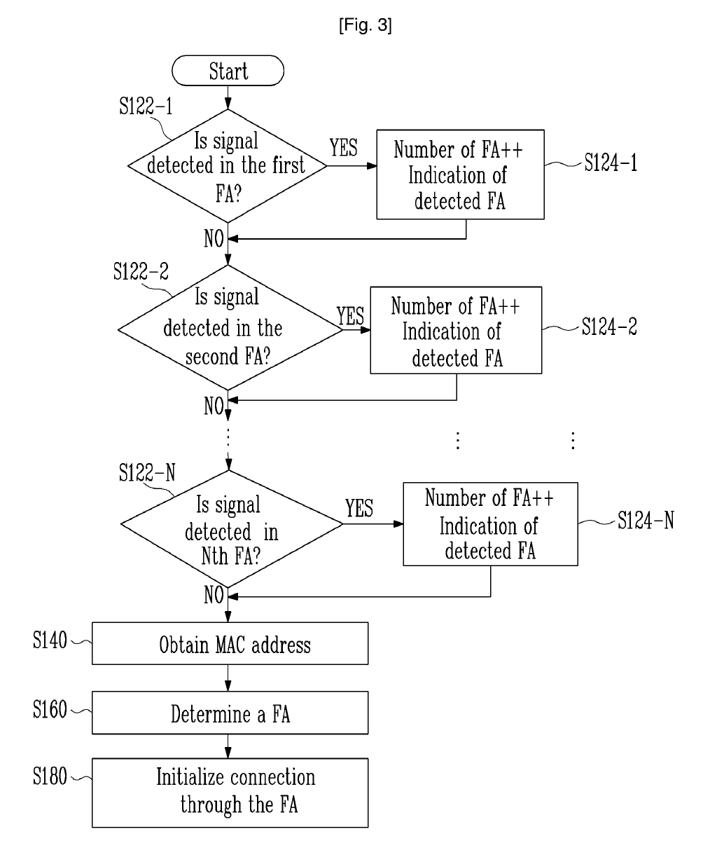

### MODE FOR THE INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

For example, in the following embodiment, while the method for determining a FA to be used depending on the information on the available FAs of the base station is implemented using a MAC address of the portable terminal, other identifiers may be used. Further, with a much simpler method, an order of each FA the base station has (e.g., in ascending order or descending order of frequency) may be designated as an order of the FAs to be used in manufacturing each terminal. In addition, FAs to be used for the terminals are recorded from the highest to the lowest order, and the FAs are sequentially found and used.

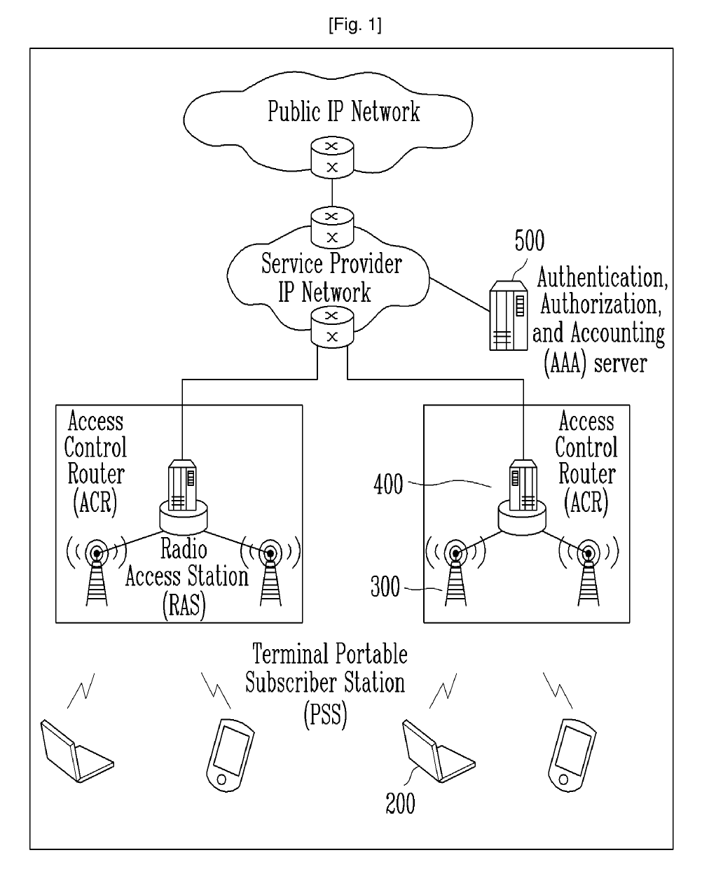

FIG. 1 schematically illustrates a configuration of a portable Internet service system according to an exemplary embodiment of the present invention. As shown in FIG. 1, the portable Internet service system includes: a Portable Subscriber Station (PSS: portable terminal) 200, which is used by a subscriber to receive portable Internet services; a Radio Access Station (RAS) 300 disposed at an end of a wired network for transmitting and receiving data to/from the portable terminal through a wireless interface; an Access Control Router (ACR) 400 for controlling the RAS and routing an IP packet; and an Authentication, Authorization, and Accounting (AAA) server 500 for performing authentication, authorization and accounting operations on subscribers and terminals so that legal subscribers connected to a portable Internet network are provided with the services.

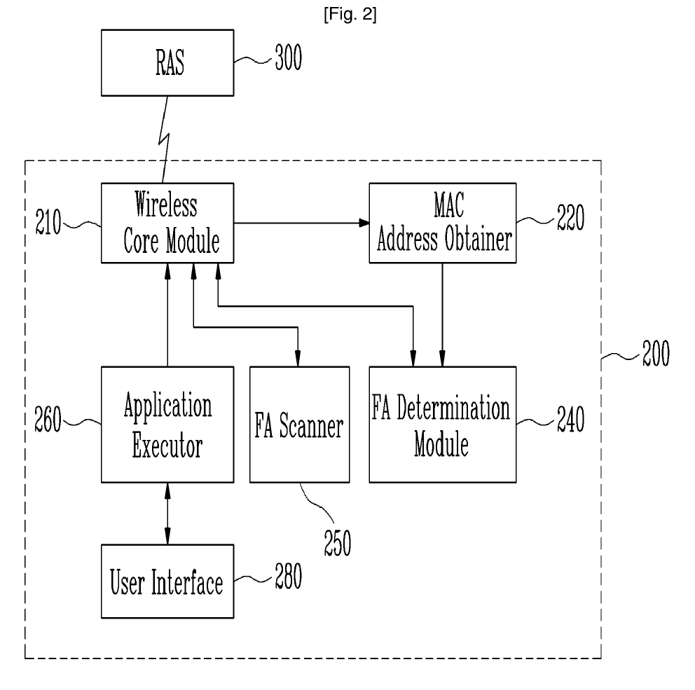

FIG. 2 schematically illustrates a block diagram of a portable terminal according to an exemplary embodiment of the present invention. The portable terminal 200 includes: a wireless core module 210 for transmitting and receiving a wireless signal to/from a portable Internet base station; a MAC address obtainer (identifier obtainer) 220 for obtaining a MAC address of the wireless core module; an FA scanner 250 for checking whether a signal for each FA is detected and obtaining the number of available FAs of a target base station (a base station to be connected to); a FA determination module 240 for determining a FA from the number of the available FAs of the base station and the obtained MAC address; an application executor 260 for performing an application for wireless Internet data communication; and a user interface 280.

With respect to devices for receiving portable Internet, a device for performing encoding/decoding of wireless protocols for portable Internet may be separated from a device for executing portable Internet applications. In a portable terminal including only the device for performing encoding/decoding of wireless protocols, the application executor and the user interface may be omitted.

A local area network (LAN) card manufactured independently of the portable terminal may be added thereto when the terminal is used. In this case, the wireless core module 210 may be a LAN card for 2˜10 GHz portable Internet, and the LAN card has a MAC address, which is an identifier. In the case of a portable terminal incorporating modules for wireless communication without a LAN card, the portable terminal itself has a specific MAC address.

In the formal case, the MAC address obtainer 220 obtains the MAC address from the wireless core module 210. The MAC address can be obtained from the wireless core module 210 through a separate internal protocol in the process of initially connecting to a wireless Internet network. In the latter case in which the terminal has a unique MAC address, the portable terminal 200 may record the corresponding MAC address electronically or by circuitry in advance when the terminal is manufactured. In this case, the MAC address obtainer 220 only reads the recorded MAC address.

The FA scanner 250 checks whether a wireless signal for each FA is detected and obtains the number of available FAs of a target base station. Therefore, the FA scanner 250 only examines whether there is a physical wave and does not analyze a received signal nor transmit a response signal, which helps to reduce power consumption. In wireless Internet based on the IEEE 802.16e standard, a center frequency is within a range of 2 to 10 GHz, and the FA scanner can scan whether a signal is detected within an interval of 125 KHz.

The FA determination module 240 includes a FA determination algorithm for receiving the number of FAs of the base station connected to the MAC address to thereby determine the FA to be used. The algorithm represented by Equation 1 is one example of the FA determination algorithms. According to Equation 1, a FA having an order corresponding to a remainder obtained by dividing the MAC address number by the number of available FAs is determined as the FA.

Order of the FAs to be used=MAC address number % number of FAs of connected base station (Equation 1)

Here, “A % B” denotes “the remainder obtained by dividing A by B”, and the order of the FAs represented by the remainder of the above equation starts at zero (0). A FA having 0^{th} order is a primary one, and 1^{st} order indicates an additional one. For example, when the connected base station operates only 1 FA(FA #1), the order of the FAs to be used on every terminal is 0, according to the above equation. Therefore, every connected portable terminal uses the primary FA (FA #1). In addition, when the base station operates 2 FAs (FA #1, FA #2), every portable terminal having an even-numbered MAC address uses the primary FA (FA #1) having 0^{th} order, and every portable terminal having an odd-numbered MAC address establishes a wireless communication channel using the additional FA (FA #2) having 1^{st} order. Moreover, when the base station operates 3 FAs (FA #1, FA #2, FA #3), every terminal having a MAC address number yielding a remainder of 0 when divided by three uses the primary FA (FA #1) having 0^{th} order. Also, the portable terminal having a MAC address number yielding a remainder of 1 uses the first additional FA (FA #2) having 1^{st} order. In addition, a terminal having a MAC address number yielding a remainder of 2 uses the second additional FA (FA #3) having 2^{nd} order to thereby form the wireless communication channel. Since there are less than 16 FAs in the base station, the least significant two (decimal system) or four (binary system) digits of the MAC address numbers are selected and Equation 1 is applied for quick calculation.

Equation 1, which represents one of the simplest algorithms, is introduced for the sake of simplicity. Alternatively, to prevent communication traffic loads from being heavily loaded on a specific FA, an algorithm that is based on a MAC address range assigned to a LAN card manufacturer, a MAC address range having a high probability of use within a certain region, an assignable MAC address range according to type of wireless communication service and/or service provider, etc., may be used.

The application executor 260 may include a CPU, etc., for executing application p rograms of the portable terminal 200. Also, the user interface 280 may be a touch screen, an image display, etc. Since the application executor 260 and the user interface 280 are similar to components of the conventional art and are not central to the present invention, detailed descriptions of these components will be omitted.

A method for determining a FA in a portable Internet terminal based on the IEEE 802.16 standard according to an exemplary embodiment of the present invention will be described below.

The method for determining a FA of the present embodiment includes the steps of: checking whether a signal for each FA is detected and obtaining the number of available FAs of a target base station (S120); obtaining a MAC address of a portable terminal (S140); determining a FA on the MAC address and the number of available FAs (S160); and performing connection initialization through the determined FA (S180).

In other words, the MAC address is used as an identifier of the portable terminal, and the number of available FAs among information on the status of available FAs is used in the present embodiment. The step of determining a FA to be used according to the status of available FAs of the base station includes the steps of: obtaining the MAC address of the portable terminal; and determining a FA to be used according to the MAC address and the information on the available FAs.

In the following description, it is assumed that the base station of the communication system based on the IEEE 802.16 standard provides three assigned FAs: FA #1, FA #2, and FA #3. Here, the primary FA is FA #1.

When the portable terminal of FIG. 2 is controlled by a portable Internet user to begin an initialization operation within a service area of a specific base station, the FA scanner scans whether a wireless signal for each FA band assigned for portable Internet is detected. In other words, an antenna is synchronized with a center frequency of one of the FA bands, which have different center frequencies, so as to sequentially determine whether the wireless signal is detected (S122-1 to S122-N). Here, for example, an ascending order or a descending order of frequency may be given for a scanning order. Further, the FA scanner sequentially records center frequencies of FAs in which wireless signals are detected (or an order of a frequency slot constituting a corresponding FA band), counts the total number of FAs in which wireless signals are detected (S124-1 to S124-N), and obtains the number of available FAs of a target base station (S120).

When the number of available FA is only one (1), the portable Internet terminal performs initialization using only the detected FA (primary one), and the process of determining the FA is terminated. When the number of available FAs is two (2) or more, a MAC address may be obtained from a LAN card, which independently exists in the portable terminal through a separate internal protocol, or a recorded MAC address may be read (S140).

The FA determination module that obtains the number of FAs and the MAC address as a result of executing steps S220 and S230 and then determines a FA to be used for portable Internet communication by applying the number of the FAs and the MAC address to the FA algorithm represented by Equation 1 (S160).

When the FA is determined by the FA determination module, a process of initializing a connection through the determined FA may be performed (S180). The process is similar to a method of changing a FA that is being used by a portable terminal according to instructions from the base station due to traffic loads heavily loaded on the FA. This will be described below.

First, it is assumed that the FA determination module determines the second additional FA (FA #3) as a FA. Initially, the portable terminal transmits a ranging request (RNG_REQ) message through the determined FA (FA #3). Then, the portable terminal receives a ranging response (RNG_RSP) message through corresponding FA #3 in response to the RNG_REQ message.

After the ranging process for portable Internet service, the base station and the portable terminal that check physical information for wireless communication perform Subscriber Station Basic Capability Negotiation (SBC Negotiation). When the portable terminal transmits an SBC Negotiation request (SBC-REQ) message to the base station, the base station receives the message and transmits a response (SBC-RSP) to the portable terminal. Through such SBC Negotiation, a network admission process for the portable terminal is completed.

When the admission process is finished, a PKM authentication process is performed. First, when the portable terminal transmits a subscriber authentication request (PKM_REQ) message to a wireless network system, the wireless network system that receives the message performs authentication through the AAA server 500, an authentication server, and then transmits the PKM_REQ message to the portable terminal. Afterwards, an IP address is assigned to the portable terminal to execute applications for wireless Internet communication.

According to a method for determining a FA of the present invention, traffic loads can be efficiently distributed to a plurality of FAs without terminal power consumption.

Also, since a MAC address, which is an identifier granted for Internet communication, is used in the present invention, a terminal does not need a separate identifier for distributing traffic loads to a plurality of FAs.

While the invention has been shown and described with reference to certain exemplary embodiments thereof, it will be understood by those skilled in the art that various changes in form and details may be made therein without departing from the spirit and scope of the invention as defined by the appended claims.

1: A method for determining a frequency assignment (FA) to be used for wireless communication, the method performed in a portable terminal and comprising the steps of:
(a) checking whether a signal for each FA is detected and obtaining the number of available FAs of a target base station;
(b) obtaining a media access control (MAC) address of the portable terminal;
(c) determining a FA based on the MAC address and the number of available FAs; and
(d) performing connection initialization through the determined FA.

2: The method of claim 1, wherein in step (a), an antenna is synchronized with a center frequency of a FA band and it is checked whether a wireless signal is detected, for each FA band.

3: The method of claim 1, wherein the checking of whether the wireless signal is detected is performed for each FA band in order of descending frequency.

4: The method of claim 1, wherein the checking of whether a wireless signal is detected is performed for each FA band in order of ascending frequency.

5: The method of claim 1, wherein step (b) comprises the step of obtaining the MAC address through an internal protocol of the portable terminal.

6: The method of claim 1, wherein step (b) comprises the step of reading the MAC address recorded in the portable terminal.

7: The method of claim 1, wherein in step (c), the FA is determined as a FA having an order corresponding to a remainder obtained by dividing the MAC address by the number of available FAs.

8: The method of claim 1, wherein step (c) is performed using an algorithm that is based on at least one of a MAC address range assigned to portable Internet, a MAC address range having a high probability of use within a region, an assigned MAC address range according to type of wireless communication service, and an assigned MAC address range according to a service provider.

9: The method of claim 1, wherein in step (e), a ranging process, a basic function negotiation process, and an authentication process are performed on the determined FA.

10: The method of claim 1, wherein the method of determining the FA is performed in the process of initializing a connection between a base station of portable Internet communication and the portable Internet terminal.

11. A portable terminal comprising:
a wireless core module for transmitting and receiving a wireless signal to and from a portable Internet base station;
a media access control (MAC) address obtainer for obtaining a MAC address from the wireless core module;
a frequency assignment (FA) scanner for checking whether a wireless signal for each FA is detected and obtaining the number of available FAs of a target base station; and
a FA determination module for determining a FA to be used according to the MAC address and the number of available FAs of the base station.

12: The portable terminal of claim 11, wherein the FA scanner synchronizes an antenna with a center frequency of a FA band and checks whether a wireless signal is detected on each FA of the base station.

13: The portable terminal of claim 11, wherein the checking of whether the signal is detected is performed for each FA band in order of descending frequency.

14: The portable terminal of claim 11, wherein the checking of whether the signal is detected is performed for each FA band in order of ascending frequency.

15: The portable terminal of claim 11, wherein the MAC address obtainer obtains the MAC address through an internal protocol of the portable terminal.

16: The portable terminal of claim 11, wherein the MAC address obtainer reads the MAC address recorded in the portable terminal.

17: The portable terminal of claim 11, wherein the FA determination module determines the FA as one having an order corresponding to a remainder obtained by dividing the MAC address by the number of available FAs.

18: The portable terminal of claim 11, wherein the FA determination module uses an algorithm that is based on at least one of a MAC address range assigned to portable Internet, a MAC address range having a high probability of use within a region, an assigned MAC address range according to type of wireless communication service, and an assigned MAC address range according to a service provider.

19: The portable terminal of claim 11, further comprising:
an application executor in communication with the wireless core module for executing an application for wireless Internet communication; and
a user interface in communication with the application executor.

20: The portable terminal of claim 11, wherein the portable terminal is a portable Internet terminal for performing portable Internet communication according to IEEE 802.16 standard.
